(19) United States
(12) Patent Application Publication
(10) Pub. No.: US 2011/0203994 A1
(43) Pub. Date: Aug. 25, 2011

(54) Forward Osmosis Separation Processes

(75) Inventors: Robert L. McGinnis, Cambridge, MA (US); Menachem Elimelech, Woodbridge, CT (US)

(73) Assignee: Yale University, New Haven, CT (US)

(21) Appl. No.: 13/000,198

(22) PCT Filed: Jun. 22, 2009
(86) PCT No.: PCT/US09/48137

§ 371 Date: May 13, 2011

Related U.S. Application Data
(60) Provisional application No. 61/074,199, filed on Jun. 20, 2008.
(60) Provisional application No. 61/074,195, filed on Jun. 20, 2008.

(51) Int. Cl. B01D 61/00

(52) U.S. Cl. 210/650

(57) ABSTRACT

Separation processes using engineered osmosis are disclosed generally involving the extraction of solvent from a first solution to concentrate solute by using a second concentrated solution to draw the solvent from the first solution across a semi-permeable membrane. One or both of the solute and solvent may be a desired product. Enhanced efficiency may result from using low grade waste heat from industrial or commercial sources.

### RELATED APPLICATIONS

This application claims the benefit of priority to U.S. Provisional Patent Application Ser. No. 61/074,195, filed Jun. 20, 2008; and to United States Provisional Patent Application Ser. No. 61/074,199, filed Jun. 20, 2008; both of which are hereby incorporated by reference in their entirety.

### FIELD OF THE TECHNOLOGY

One or more aspects relate generally to osmotic separation. More particularly, one or more aspects involve use of engineered osmosis processes, such as forward osmosis, to separate solutes from aqueous solutions for wastewater purification and product recovery in high purity applications, for example, in the food and pharmaceutical industries.

### BACKGROUND

In various applications it may be desirable to concentrate species of interest which are present in solution. In some conventional techniques, heat may be applied to change the phase of the solvent to remove it from the solution thereby providing the species of interest in a higher concentration. Other conventional approaches involve hydraulic pressure driven membrane processes used to push solvent through a membrane which is permeable to the solvent but impermeable to the species of interest. In the context of wastewater treatment, membrane bioreactors have widely replaced traditional secondary wastewater treatment methods for the removal of organic matter from aqueous waste streams. A hydraulic pressure-driven membrane system is typically used to separate water from a biologically active solution in which organic matter is consumed by microorganisms as food, these microorganisms then being separately removed as sludge.

### SUMMARY

Aspects relate generally to systems and methods for osmotic separation of solutes in solution.

In accordance with one or more embodiments, a forward osmosis separation process is disclosed. The process may comprise introducing a first solution comprising a solvent and at least one target species on a first side of a semi-permeable membrane. The process may further comprise introducing a second solution comprising ammonia and carbon dioxide in a molar ratio of at least 1:1 on a second side of the semi-permeable membrane, thereby forming an osmotic concentration gradient across the semi-permeable membrane which promotes the flow of at least a portion of the solvent of the first solution across the semi-permeable membrane to form a third solution on the first side of the semi-permeable membrane and a fourth solution on the second side of the semi-permeable membrane. The process may further comprise promoting the flow of at least a portion of the fourth solution to a separation operation to thereby generate draw solutes a solvent stream. The process may further comprise returning the draw solutes to the second side of the semi-permeable membrane. The process may further comprise recovering the at least one target species from the third solution.

In some embodiments, the first solution may be an aqueous solution. In at least one embodiment, the first solution may comprise a stream from a pharmaceutical or food grade operation. The target species may comprise a salt, sugar, enzyme, protein or microorganism. In some embodiments, introducing the first solution on a first side of the semi-permeable membrane comprises immersing the semi-permeable membrane in the first solution. Introducing the second solution may comprise directing the second solution along the second side of the semi-permeable membrane. In at least one embodiment, the first solution is introduced continuously.

In one or more embodiments, introducing at least a portion of the fourth solution to a separation operation comprises introducing at least a portion of the fourth solution to a distillation column, membrane distillation system or pervaporation system. Waste heat may be supplied to the separation operation in some embodiments. In at least one embodiment, the process may further comprise a step of processing the solvent stream.

In some embodiments, recovering the at least one target species comprises introducing the third solution to a settling vessel, hydrocyclone, precipitator, or force gradient operation. In some embodiments, the process may further comprise introducing the at least one recovered target species to a further treatment unit. The at least one treated target species may be supplied to a downstream point of use.

In accordance with one or more embodiments, a forward osmosis waste treatment process is disclosed. The process may comprise introducing a first solution comprising a solvent and at least one constituent on a first side of a semi-permeable membrane. In some embodiments, the process may further include introducing a concentrated draw solution comprising ammonia and carbon dioxide in a molar ratio of at least 1:1 on a second side of the semi-permeable membrane to maintain an osmotic concentration gradient across the semi-permeable membrane. In some embodiments, the process may further include promoting flow of at least a portion of the solvent of the first solution across the semi-permeable membrane to form a second solution on the first side of the semi-permeable membrane and a dilute draw solution on the second side of the semi-permeable membrane. In some embodiments, the process may further include introducing at least a portion of the dilute draw solution to a separation operation to thereby generate draw solutes and a solvent stream. In some embodiments, the process may further include returning the draw solutes to the second side of the semi-permeable membrane. In some embodiments, the process may further include removing the at least one constituent from the second solution.

In some embodiments, the first solution comprises wastewater. The first solution may comprise salts, organic matter, suspended colloids or biological organisms. In at least one embodiment, introducing the first solution on the first side of the semi-permeable membrane comprises immersing the semi-permeable membrane in the first solution. Introducing the concentrated draw solution may comprise directing the concentrated draw solution along the second side of the semi-permeable membrane. In at least one embodiment, the first solution is introduced continuously.

In some embodiments, introducing at least a portion of the dilute draw solution to a separation operation comprises introducing at least a portion of the dilute draw solution to a distillation column, membrane distillation system or pervaporation system. The process may further include a step of supplying waste heat to the separation operation. In at least one embodiment, the process may further include processing the solvent stream. Removing the at least one undesirable constituent may comprise introducing the second solution to a settling vessel, hydrocyclone or blowdown operation. The at least one undesirable constituent may be introduced to a further treatment operation.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures. In the figures, which are not intended to be drawn to scale, each identical or nearly identical component that is illustrated in various figures is represented by a like numeral. For purposes of clarity, not every component may be labeled in every drawing. The figures are provided for the purposes of illustration and explanation and are not intended as a definition of the limits of the invention. In the figures:

FIG. 1 presents a schematic diagram of a separation method in accordance with one or more embodiments;

FIG. 2 presents a detailed schematic diagram of a separation method in accordance with one or more embodiments;

FIG. 3 presents a diagram of an apparatus used in a separation method in accordance with one or more embodiments; and

FIG. 4 presents a schematic diagram of an apparatus used in a separation method in accordance with one or more embodiments.

### DETAILED DESCRIPTION

In accordance with one or more embodiments, disclosed separation methods may be used to extract various types of solutes from various types of solvents in solution. Desired products of the disclosed methods may be the solvent, the solute or both. In some embodiments, methods may be used for the concentration of solutes. In at least one embodiment, products such as salts, sugars, pharmaceuticals or other compounds may be recovered from a process stream. In other embodiments, waste streams such as wastewater may be treated to recover purified water for downstream use.

In accordance with one or more embodiments, an osmotic method for extracting solvent from solution may generally involve exposing the solution to a first surface of a forward osmosis membrane. In some embodiments, the first solution (known as a process or feed solution) may be seawater, brackish water, wastewater, contaminated water, a process stream or other aqueous solution. In at least one embodiment, the solvent is water but other embodiments pertain to nonaqueous solvents. A second solution (known as a draw solution) with an increased concentration of solute relative to that of the first solution, may be exposed to a second opposed surface of the forward osmosis membrane. Solvent, for example water, may then be drawn from the first solution through the forward osmosis membrane and into the second solution generating a solvent-enriched solution via forward osmosis. Forward osmosis generally utilizes fluid transfer properties involving movement from a less concentrated solution to a more concentrated solution. Osmotic pressure generally promotes transport of solvent across a forward osmosis membrane from feed to draw solutions. The solvent-enriched solution, also referred to as a dilute draw solution, may be collected at a first outlet and undergo a further separation process. In some non-limiting embodiments, purified water may be produced as a product from the solvent-enriched solution. A second product stream, i.e. a depleted or concentrated process solution, may be collected at a second outlet for discharge or further treatment. The concentrated process solution may contain one or more target compounds which it may be desirable to concentrate or otherwise isolate for downstream use.

In accordance with one or more embodiments, a forward osmosis separation system may include one or more forward osmosis membranes. The forward osmosis membranes may generally be semi-permeable, for example, allowing the passage of solvent such as water, but excluding dissolved solutes therein, such as sodium chloride, ammonium carbonate, ammonium bicarbonate, ammonium carbamate, other salts, sugars, drugs or other compounds. Many types of semi-permeable membranes are suitable for this purpose provided that they are capable of allowing the passage of water (i.e., the solvent) while blocking the passage of the solutes and not reacting with the solutes in the solution. The membrane can have a variety of configurations including thin films, hollow fiber membranes, spiral wound membranes, monofilaments and disk tubes. There are numerous well-known, commercially available semi-permeable membranes that are characterized by having pores small enough to allow water to pass while screening out solute molecules such as sodium chloride and their ionic molecular species such as chloride. Such semi-permeable membranes can be made of organic or inorganic materials. In some embodiments, membranes made of materials such as cellulose acetate, cellulose nitrate, polysulfone, polyvinylidene fluoride, polyamide and acrylonitrile co-polymers may be used. Other membranes may be mineral membranes or ceramic membranes made of materials such as ZrO₂ and TiO₂.

Preferably, the material selected for use as the semi-permeable membrane should generally be able to withstand various process conditions to which the membrane may be subjected. For example, it may be desirable that the membrane be able to withstand elevated temperatures, such as those associated with sterilization or other high temperature processes. In some embodiments, a forward osmosis membrane module may be operated at a temperature in the range of about 0 degrees Celsius to about 100 degrees Celsius. In some non-limiting embodiments, process temperatures may range from about 40 degrees Celsius to about 50 degrees Celsius. Likewise, it may be desirable for the membrane to be able to maintain integrity under various pH conditions. For example, one or more solutions in the membrane environment, such as the draw solution, may be more or less acidic or basic. In some non-limiting embodiments, a forward osmosis membrane module may be operated at a pH level of between about 2 and about 11. In certain non-limiting embodiments, the pH level may be about 7 to about 10. The membranes used need not be made out of one of these materials and they can be composites of various materials. In at least one embodiment, the membrane may be an asymmetric membrane, such as with an active layer on a first surface, and a supporting layer on a second surface. In some embodiments, an active layer may generally be a rejecting layer. For example, a rejecting layer may block passage of salts in some non-limiting embodiments. In some embodiments, a supporting layer, such as a backing layer, may generally be inactive.

In accordance with one or more embodiments, at least one forward osmosis membrane may be positioned within a housing or casing. The housing may generally be sized and shaped to accommodate the membranes positioned therein. For example, the housing may be substantially cylindrical if housing spirally wound forward osmosis membranes. The housing of the module may contain inlets to provide feed and draw solutions to the module as well as outlets for withdrawal of product streams from the module. In some embodiments, the housing may provide at least one reservoir or chamber for holding or storing a fluid to be introduced to or withdrawn from the module. In at least one embodiment, the housing may be insulated.

In accordance with one or more embodiments, a forward osmosis separation system may generally be constructed and arranged so as to bring a first solution and a second solution into contact with first and second sides of a semi-permeable membrane, respectively. Although the first and second solutions can remain stagnant, it is preferred that both the first and second solutions are introduced by cross flow, i.e., flows parallel to the surface of the semi-permeable membrane. This may generally increase membrane surface area contact along one or more fluid flow paths, thereby increasing the efficiency of the forward osmosis. In some embodiments, the first and second solutions may flow in the same direction. In other embodiments, the first and second solutions may flow in opposite directions. In at least some embodiments, similar fluid dynamics may exist on both sides of a membrane surface. This may be achieved by strategic integration of the one or more forward osmosis membranes in the module or housing.

In accordance with one or more embodiments, methods may achieve a high yield of solvent extraction without excessive energy demands and/or environmentally harmful waste discharge. Solvent may be extracted to concentrate solutes, such as desirable target species, from a process stream in an energy efficient manner that results in high yields. The solvent and/or recovered solutes from the process stream may be desired end products. Solutes in the draw solution may also be recycled within the process.

A separation process in accordance with one or more embodiments may involve exposing a first solution to a first surface of a semi-permeable membrane. A second solution that has a concentration greater than that of the first solution may be exposed to a second opposed surface of this membrane. In some embodiments, the concentration of the second solution may be increased by using a first reagent to adjust the equilibrium of solutes within the second solution to increase the amount of a soluble species of solute within the second solution. The concentration gradient between the first and second solutions then draws the solvent from the first solution through the semi-permeable membrane and into the second solution producing a solvent-enriched solution. In accordance with one or more embodiments, a portion of the solutes may be recovered from the solvent-enriched second solution and recycled to the draw solution. The recovery process may yield a solvent product stream. The concentration gradient also produces a depleted solution on the first side of the semi-permeable membrane which may be discharged or further processed. The depleted solution may include one or more target species of which concentration or recovery is desired.

In accordance with one or more embodiments, an apparatus for the extraction of a solvent from a first solution using osmosis is disclosed. In one non-limiting embodiment of the apparatus, the apparatus has a first chamber with an inlet and an outlet. The inlet of the first chamber may be connected to a source of the first solution. A semi-permeable membrane separates the first chamber from a second chamber. The second chamber has an inlet and a first and second outlet. In some embodiments, a third chamber may receive a solvent-enriched second solution from the first outlet of the second chamber and a reagent from the second outlet of the second chamber. The third chamber may include an outlet which is connected to a separation operation, such as a filter for filtering the solvent-enriched second solution. The filter may have a first and second outlet with the first outlet connected to the inlet of the second chamber in order to recycle a precipitated solute to the second chamber. In some embodiments, a fourth chamber may receive the solvent-enriched second solution from the second outlet of the separation operation. The fourth chamber may have a heater for heating the solvent-enriched second solution. A first outlet in the fourth chamber may return constituent gasses to the inlet of the second chamber. As discussed herein, various species, such as the gases from the fourth chamber and/or precipitated solute from the third chamber, may be recycled within the system. Such species may be introduced, for example to the second chamber, at the same inlet or at different inlets. A second outlet in the fourth chamber may permit a final product, the solvent, to exit the apparatus.

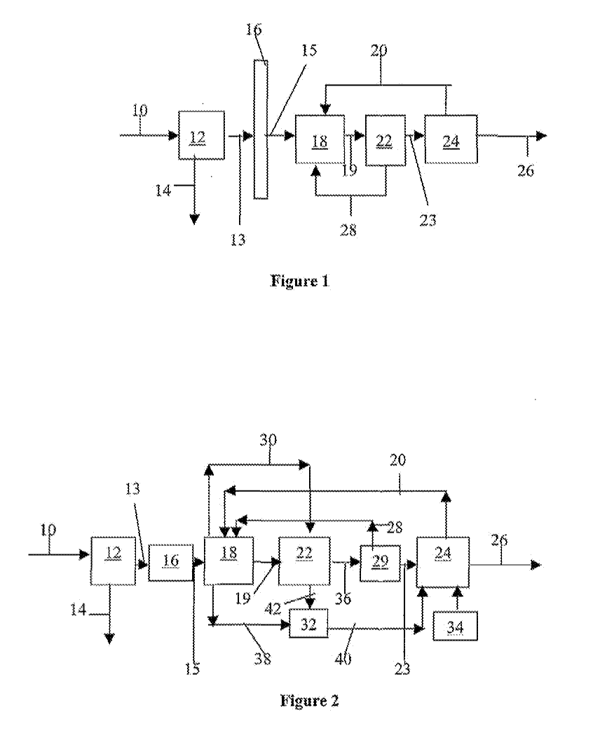

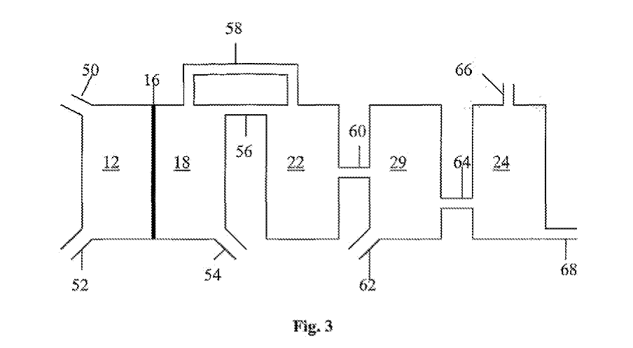

FIG. 1 shows an overview diagram of a forward osmotic separation method in accordance with one or more embodiments, the details of which are further described with reference to FIG. 2. As shown in FIG. 1, a solution (10), for example, seawater, brackish water, wastewater, contaminated water or other solution, referred to as the first solution, is disposed in a first chamber (12). The first chamber (12) is in fluid communication with a semi-permeable membrane (16) as illustrated by arrow (13). A second solution having a concentration greater than the first solution is contained in second chamber (18). The higher concentration solution enables the solvent, i.e., the water, from the first solution in the first chamber (12) to osmose across the semi-permeable membrane (16) into the more concentrated second solution located within the second chamber (18) as illustrated by arrow (15). Having lost much of its solvent, the remaining first solution in the first chamber (12) is concentrated in solute. The solute may be discarded as illustrated by arrow (14) if considered a waste product. Alternatively, the solute may be a target compound and may be collected for further processing or downstream use as a desired product. The resulting solvent-enriched second solution in the second chamber (18) is then introduced, as illustrated by arrow (19), into a third chamber (22). In the third chamber (22) solutes in the solvent-enriched second solution may be separated out and recycled back into second chamber (18), as illustrated by arrow (28), to maintain the concentration of the second solution. The remaining solvent-enriched second solution in the third chamber (22) may then be introduced, as illustrated by arrow (23), into a fourth chamber (24). In the fourth chamber (24) the remaining solvent-enriched second solution may be heated to remove any remaining solutes to produce a solvent stream, illustrated by arrow (26). In some embodiments, such as those involving treatment of wastewater, the solvent stream may be purified water. In the fourth chamber (24), heat may remove any remaining solutes by breaking them down into their constituent gasses, the gasses may be returned to the second chamber (18) as illustrated by arrow (20) to maintain the concentration gradient of the second solution in chamber (18) and act as reagent.

As noted above, a separation process in accordance with one or more embodiments may start with the first solution contained within the first container (12). The first solution may be an aqueous or nonaqueous solution that is being treated, either for the purpose of purified water recovery, for the removal of undesirable solutes, or for the concentration and recovery of desired solutes. Included among undesirable solutes are undesired chemically precipitable soluble salts such as sodium chloride (NaCl). Typical examples of the first solution include aqueous solutions such as seawater, brine and other saline solutions, brackish water, mineralized water, industrial waste water, and product streams associated with high purity applications, such as those affiliated with the food and pharmaceutical industries. The first solution described herein may be an aqueous solution or a nonaqueous solution. In general, any type of solvent compatible with the draw solution may be used, for example, any solvent capable of withstanding the pH, temperature and other characteristics of the draw solution. The first solution may be filtered and pre-treated in accordance with known techniques in order to remove solid and chemical wastes, biological contaminants, and otherwise prevent membrane fouling, prior to osmotic separation and is then supplied to the first chamber (12) as indicated by arrow 10.

In accordance with one or more embodiments, the first solution may be any solution containing solvent and one or more solutes for which separation, purification or other treatment is desired. In some embodiments, the first solution may be non-potable water such as seawater, salt water, brackish water, gray water, and some industrial water. It may be desired to produce purified or potable water from such a stream for downstream use. A process stream to be treated may include salts and other ionic species such as chloride, sulfate, bromide, silicate, iodide, phosphate, sodium, magnesium, calcium, potassium, nitrate, arsenic, lithium, boron, strontium, molybdenum, manganese, aluminum, cadmium, chromium, cobalt, copper, iron, lead, nickel, selenium, silver and zinc. In some examples, the first solution may be brine, such as salt water or seawater, wastewater or other contaminated water. In other embodiments, the first solution may be a process stream containing one or more solutes, such as target species, which it is desirable to concentrate, isolate or recover. Such streams may be from an industrial process such as a pharmaceutical or food grade application. Target species may include pharmaceuticals, salts, enzymes, proteins, catalysts, microorganisms, organic compounds, inorganic compounds, chemical precursors, chemical products, colloids, food products or contaminants. The first solution may be delivered to a forward osmosis membrane treatment system from an upstream unit operation such as industrial facility, or any other source such as the ocean.

Like the first solution, the second solution may be an aqueous solution, i.e., the solvent is water. In other embodiments, nonaqueous solutions such as organic solvents may be used for the second solution. The second solution may be a draw solution containing a higher concentration of solute relative to the first solution. A wide variety of draw solutions may be used. For example, the draw solution may comprise a thermolytic salt solution. In some embodiments, an ammonia and carbon dioxide draw solution may be used, such as those disclosed in U.S. Patent Application Publication Number 2005/0145568 to McGinnis which is hereby incorporated herein by reference in its entirety for all purposes. In one embodiment, the second solution may be a concentrated solution of ammonia and carbon dioxide. In at least one embodiment, the draw solution may comprise ammonia and carbon dioxide in a molar ratio of greater than 1 to 1.

The draw solution generally has a concentration of solute greater than that of the feed solution. This may be achieved using solutes that are soluble enough to produce a solution that has a higher concentration than the feed solution. One or more characteristics of the draw solution may be adjusted based on the process stream supplied to the separation system for treatment. For example, the volume, flow rate or concentration of solutes in the feed solution may impact one or more parameters selected for the draw solution. Requirements pertaining to discharge streams associated with the system may also impact one or more operational parameters. Other operational parameters may also be varied based on an intended application of the forward osmosis separation system. Preferably, the solute within the second solution should be easily removable from solution through a separation process, wherein said separation process separates the solute into at least one species that is more readily dissolved in the solvent of the solution, i.e., the soluble species, and one species that is not readily dissolved within the solvent, i.e., the less-soluble species, and the solute should pose no health risk if trace amounts remain in the resulting solvent. The existence of the soluble and less-soluble species of solutes allows for the solutions to be adjusted or manipulated as needed. Typically, the soluble and less-soluble solute species reach a point in solution in which, under the particular condition temperature, pressure, pH, etc., neither species of solute is either increasing or decreasing with respect to the other, i.e., the ratio of the soluble to insoluble species of solute is static. This is referred to as equilibrium. Given the particular conditions of the solution, the species of solute need not be present in a one to one ratio at equilibrium. Through the addition of a chemical, referred to herein as a reagent, the balance between the species of solutes can be shifted. Using a first reagent, the equilibrium of the solution can be shifted to increase the amount of the soluble species of solute. Likewise, using a second reagent, the equilibrium of the solution may be shifted to increase the amount of the less-soluble solute species. After the addition of the reagents, the ratio of species of solutes may stabilize at a new level which is favored by the conditions of the solution. By manipulating the equilibrium in favor of the soluble species of solute, a second solution with a concentration near saturation can be achieved, a state in which the solutions solvent cannot dissolve anymore of the solute.

Preferred solutes for the second (draw) solution may be ammonia and carbon dioxide gases and their products, ammonium carbonate, ammonium bicarbonate, and ammonium carbamate Ammonia and carbon dioxide, when dissolved in water at a molar ratio of about 1, form a solution comprised primarily of ammonium bicarbonate and to a lesser extent the related products ammonium carbonate and ammonium carbamate. The equilibrium in this solution favors the less-soluble species of solute, ammonium bicarbonate, over the soluble species of solute, ammonium carbamate and to a lesser extent ammonium carbonate. Buffering the solution comprised primarily of ammonium bicarbonate with an excess of ammonia gas so that the molar ratio of ammonia to carbon dioxide is greater than 1 will shift the equilibrium of the solution towards the more soluble species of the solute, ammonium carbamate. The ammonia gas is more soluble in water and is preferentially adsorbed by the solution. Because ammonium carbamate is more readily adsorbed by the solvent of the second solution, its concentration can be increased to the point where the solvent cannot adsorb anymore of the solute, i.e. saturation. In some non-limiting embodiments, the concentration of solutes within this second solution achieved by this manipulation is greater than about 2 molal, more than about 6 molal, or about 6 molal to about 12 molal.

Ammonia gas may be a preferred first reagent for ammonium carbamate since it is one of the chemical elements that results when the solute ammonium carbamate is decomposed, otherwise referred to as a constituent element. In general, it is preferred that the reagent for the solvent be a constituent element of the solute since thereby any excess reagent can easily be removed from the solution when the solvent is removed, and, in a preferred embodiment, the constituent element can be recycled as the first reagent. However, other reagents that can manipulate the equilibrium of the solute species in solution are contemplated so long as the reagent is easily removed from the solution and the reagent posses no health risk if trace elements of the reagent remain within the final solvent.

In accordance with one or more embodiments, a separation process may begin by bringing the first solution and the second solution into contact with the first and second sides of the semi-permeable membrane (16), respectively. Although the first and second solutions can remain stagnant, it is preferred that both the first and second solutions are introduced by cross flow, i.e., flows parallel to the surface of the semi-permeable membrane (16). This increases the amount of surface area of the semi-permeable membrane (16) a given amount of the solutions comes into contact with thereby increasing the efficiency of the forward osmosis. Since the second solution in the second chamber (18) has a higher solute concentration than the first solution in the first chamber (12), the solvent in the first solution diffuses to the second solution by forward osmosis. In some embodiments, the difference in concentration between the two solutions is so great that the solvent passes through the semi-permeable membrane (16) without the addition of pressure to the first solution. Overall, this process may result in the removal of about 90% to about 99.9% of the solvent contained within the first solution. During the separation process, the first solution becomes more concentrated as it loses solvent and the second solution becomes more diluted as it gains solvent. Despite this occurrence, the concentration gradient between the two solutions remains significant. The depleted solution on the first side of the membrane, and the diluted solution on the second side of the membrane may each be further processed for the recovery of one or more desired products. For example, the depleted solution on the first side of the membrane may contain solutes which are target species whose concentration and recovery is desired. Alternatively, the depleted solution on the first side of the membrane may be discarded as waste. Likewise, the diluted solution on the second side of the membrane may be rich in solvent which may be a desired product.

The discharge (14), i.e, the concentrated first solution has a greater concentration of solutes. Thus, the excess solutes can be removed from the concentrated first solution prior to returning the first solution to its source or recirculating the first solution through the present method. This can be done, for example in some non-limiting embodiments, by contacting the concentrated first solution with a solar evaporator, a mechanism of simple screen filtration, hydrocyclone, or a precipitation mass or other nucleation point, to precipitate the solute. This precipitated solute may be further processed to make it suitable for consumer or industrial purposes.

Having extracted the solvent of the first solution into the second solution by forward osmosis, thereby forming a solvent-enriched second solution, it may then be desirable to remove the solutes from the solvent-enriched second solution to isolate the solvent. In some non-limiting embodiments, this can be accomplished by precipitating the solutes out of the solution, decomposing the solutes into their constituent gasses that vaporize out of solution, distilling the solvent out of the solution or absorption of the solutes onto a surface. In at least one embodiment, removing a portion of the solutes by precipitation decreases the amount of energy required to heat the solution to decompose the remaining solutes, and decomposition results in the complete removal of the solutes. Potential precipitation and decomposition steps are described with reference to the third and fourth chamber (22, 24), respectively.

The solvent-enriched second solution in the second chamber (18) may be withdrawn to a third chamber (22), as shown by arrow (19). The solvent-enriched second solution may then be treated to remove a portion of the solutes from the solvent-enriched solution by precipitation. A second reagent may be introduced to adjust the equilibrium of the soluble and less-soluble solute species in favor of the less-soluble solute species. As with the first reagent, any chemical capable of adjusting the equilibrium is suitable so long as it is easily removed from the solvent-enriched second solution and posses no health risk. Preferably the reagent is a constituent element of the solute, and in the case of the preferred solute ammonium carbamate is carbon dioxide gas. In some non-limiting embodiments, when the solvent-enriched second solution is diffused with carbon dioxide, the ratio of ammonia to carbon dioxide in solution may be reduced to around between 0.5 and 1.5 and the equilibrium in the solvent-enriched second solution shifts back towards the less-soluble species of solute, ammonium bicarbonate. The less-soluble species of solute may then precipitate out of solution. The precipitation of the ammonium bicarbonate may result in a substantial reduction in the concentration of solutes within the solvent-enriched second solution to about 2 to 3 molal. Preferably, the temperature of the solvent-enriched second solution in the third chamber (22) is lowered to about 18 to 25° C., preferably 20 to 25° C. to assist in the precipitation of the solute. The precipitated solute may then be filtered from the solution.

Referring now to FIG. 2, although the precipitated solute may be filtered within the third chamber (22), the solution may be directed to a filtration chamber (29) as shown by arrow (36). Using well known methods, such as a hydrocyclone, a sedimentation tank, column filtration, or a simple screen filtration, the precipitated solute may be removed from the solvent-enriched solution. For example, the precipitate may be allowed to settle out of solution by gravity and then siphoned off. The remaining solvent-enriched second solution may be transferred from the filter chamber (29) to a fourth chamber (24), as shown by arrow (23), where it is then heated to decompose the solutes into their constituent gasses. In one preferred embodiment, these constituent gasses may be ammonia and carbon dioxide. The energy required for the separation process is the heat required to raise the temperature of the solution to a temperature which results in the complete removal of the ammonium carbamate solute. Additional heat is also required to make up for the inefficiency of heat transfer of the enthalpies of vaporization and solution of the solutes recycled within the process. Specifically, heating causes the remaining solutes in the solvent-enriched second solution to decompose into their constituent gases, which leave the solution. In some embodiments, a vacuum or air flow may be maintained over the solvent-enriched second solution while it is being heated in order to improve the efficiency with which the decomposition gases vaporize out of solution. By generating the air flow over the fourth chamber it may be possible to remove all the solutes at a lower temperature than typically used. This decomposition may result in a solvent product, such as a potable water product, which may be further treated for end use. In general, a potable water product should have a pH of about 7, and further pH adjustments may be necessary to make the water suitable for its intended purpose.

The solvent-enriched second solution may be heated using a combination of external heat sources (34) and heat pumped through a heat exchanger (32) from the exothermic introduction of gasses and solutes (38, 42). The external heat source (34) may be supplied by any thermal source including solar and geothermal energy. The sources may be similar to those of distillation. In some embodiments, the sources may be primarily from cogeneration environments, making use of waste heat from power generation or industrial processes. Furthermore, the process efficiency may be maintained by using a heat exchanger (32) to capture the heat released during the previous steps in the present method of desalination. As shown by the arrows (38) and (42) in FIG. 2, heat released from the chemical reactions within the second and third chambers (18, 22) may be pumped to the heat pump (32) that then pumps this heat to the fourth chamber (24) to assist in heating the solvent-enriched second solution, as shown by arrow (40). In an alternative embodiment, additional heat is generated by allowing the constituent gases released to condense on the exterior of the chamber (24) in which the solvent-enriched second solution is being heated, thus, transferring the energy from this exothermic reaction to the fourth chamber (24). The condensate, which in one preferred embodiment is ammonium carbamate, may then be recycled to the second solution in the second chamber (18).

It is also preferable to recycle the solutes and solute constituents removed from the second solution to limit the environmental impact and cost of the present method of forward osmosis separation. The precipitated solute discarded from a filtration chamber may be recycled to the second chamber (18) where it can dissolve in the second solution and thereby maintain the high concentration of the second solution, as shown by arrow (28). Additionally, the constituent gasses removed from the solvent-enriched second solution in the fourth chamber (24) can be recycled back to the second or third chambers (18, 22) as shown by arrows (20) and (30), respectively, where they act as reagents. In one preferred embodiment, the solute is ammonium carbamate, which is decomposed into its constituent gasses: ammonia and carbon dioxide. These gasses are then recycled to the second chamber (18) as shown by arrow (20). Since the ammonia is more soluble than the carbon dioxide, the ammonia is preferentially adsorbed by the second solution and acts as a reagent by adjusting the equilibrium of the solute species in favor of ammonia carbamate. The remaining carbon dioxide is withdrawn from the second chamber (18), as shown in arrow (30), and transferred to the third chamber (22) where it acts as a reagent and alters the equilibrium of the second solution in favor ammonium bicarbonate. Since some preferred embodiments contemplate recycling the constituent gases derived from the decomposition of the solutes, it may be necessary to precipitate less than optimal amounts of the solutes to ensure that enough gas is recycled to maintain the efficiency of the present process. Typically, removing about half of the solutes from solution by precipitation should assure that sufficient amounts of the constituent gases will be generated to maintain the present process.

The process described herein may be conducted continuously, or in batches, to better isolate the solutes from solvent throughout the process.

One non-limiting embodiment of an apparatus for conducting the present method is detailed in FIG. 3. The apparatus has a first chamber (12) that has an inlet (50) and outlet (52). The inlet for the first chamber (50) is in communication with a source for the first solution, such as a holding tank for solution having undergone pre-treatment or being introduced from an upstream operation, or to a natural source for the first solution, such as the sea, a lake, stream or other bodies of water and waterways. The inlet for the first chamber (50) may incorporate a pump in order to siphon the first solution from its source. It also may optionally include heating or cooling devices in order to adjust the temperature of the first solution. Similarly, the outlet for the first chamber (52) may incorporate a pump in order to extract the first solution from the first chamber (12). The outlet (52) may be used to recirculate the first solution directly to the source for the first solution, although preferably, the first solution will be pumped into or across a precipitation device prior to being returned to the source of the first solution. Such a precipitation device may include a solar evaporation bed, a mechanism of simple screen filtration, a hydrocyclone, or a precipitation mass or other nucleation point operation or other types known to those skilled in the art. The first chamber (12) is separated from a second chamber (18) by a semi-permeable membrane (16).

The second chamber (18) has an inlet (54) and a first and second outlets (56, 58). The inlet (54) provides a source for the second solution and may incorporate a pump as well as heating device. The first outlet for the second chamber (56) is in communication with a third chamber (22), and provides a conduit for transferring the solvent-enriched second solution to the third chamber (22). This first outlet for the second chamber (56) can incorporate a pump to withdraw the water-enriched second solution from the second chamber (18). In another embodiment of the present invention, the first outlet for the second chamber (56) may incorporate a cooling device to cool the solvent-enriched second solution as discussed above. The second outlet for the second chamber (58) provides a conduit for any gas formed when the solvent from the first solution is drawn through the semi-permeable membrane (16) into the second solution, which in the preferred embodiment would be carbon dioxide gas, to be transferred to the third chamber (22).

In some embodiments, the third chamber (22) is where a portion of the solute is precipitated out of the solvent-enriched second solution. The third chamber (22), in addition to the inlets for (56) and (58), has an outlet (60) in communication with a filtration device (29) for separating the precipitate from the solvent-enriched second solution. The filtration device (29) is of any of the types disclosed above, although it preferably is a sedimentation tank. The filtration device (29) has two outlets: the first outlet (62) may be used to dispose of the precipitated solute or return it to the second chamber (18) through the second chamber inlet (54), and the second outlet (64) may be used to transfer the remaining solvent-enriched second solution to the fourth chamber (24). In an alternate embodiment, the filtration device (29) may be incorporated into the third chamber (22) in which case the third chamber (22) will have an additional outlet, one outlet to transfer the remaining solvent-enriched second solution to the fourth chamber (24) and another outlet to dispose of the precipitated solute or, in the preferred embodiment, return the precipitated solute to the second chamber (18) through the second chamber inlet (54).

The fourth chamber (24) may incorporate a heating device for heating the remaining solvent-enriched second solution. The fourth chamber (24) also incorporates a first outlet (66), which may incorporate a vacuum, fan, or other device for generating airflow, for venting the constituent gasses. Preferably, the first outlet for the fourth chamber (66) is in communication with the inlet (54) for the second chamber (18) to recycle the constituent gasses as the second solute. The second outlet (68) acts as a conduit for withdrawing the final solvent product, such as potable or purified water.

Any materials may be used to construct the various holding and/or storage devices (chamber, vessels and receptacles), conduits, piping, and related equipment, as long as they will withstand the weight of the solutions, and be unreactive with any solutes within the solutions. Typical materials are non-corrosive, non-reactive materials such as stainless steel, plastic, polyvinyl chloride (PVC), fiberglass, and so forth. The vessels can take any suitable configuration, but are typically cylindrical tanks, contoured or fitted tanks, and so forth. The receptacles are typically water towers, cylindrical tanks, contoured or fitted tanks, and so forth. As discussed above, it is important to note that the chambers are shown as separate units but the invention is not limited to that configuration, and where appropriate, any number of chambers can be contained within a single vessel, for example, partitioned into two chambers separated by the semi-permeable membrane (16).

The heating and cooling devices can be electrical heaters, refrigeration units, solar collectors, and heat exchangers such as steam condensers, circulators and so forth, such as are well known in the art, but preferably heat exchangers. The heating and cooling devices, along with any other equipment used within the process, that may have power requirements, can derive their energy from any variety of commonly used sources, including by means of illustration and not limitation, waste steam, solar energy, wind or geothermal energy, and conventional sources.

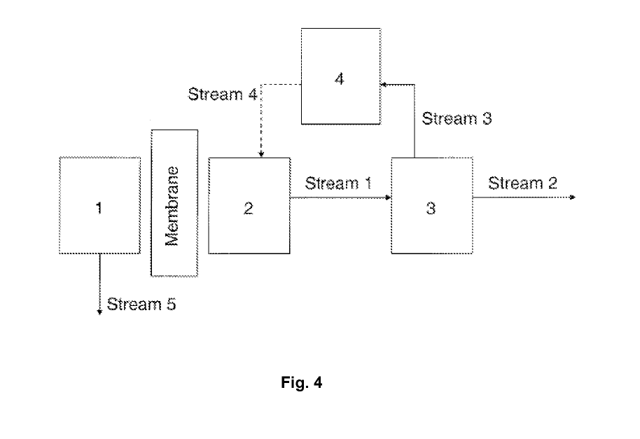

With reference to FIG. 4, a concentration process in accordance with one or more embodiments is disclosed. A first solution (1) is exposed to one side of a forward osmosis membrane. In embodiments where the first solution comprises a waste stream to be treated, the first solution is typically aqueous and contains a solution of species such as salts, proteins, catalysts, microorganisms, organic or inorganic chemicals, chemical precursors or products, colloids, or other constituents. In embodiments where the first solution contains desired target species to be concentrated and recovered, the first solution may comprise a pharmaceutical, salt, enzyme, protein, catalyst, microorganism, organic compound, inorganic compound, chemical precursor, chemical product, colloid, food product or contaminant. The exposure of the first solution to one side of the membrane may be achieved in many configurations, two of which are immersion of the membrane in the solution or direction of the solution past the membrane. This solution may be introduced continuously, in batch, once or many times, to a vessel or direction means. This input stream of the first solution (1) is not shown in the schematic.

A second solution (2), for example comprised of species including water, ammonia, and carbon dioxide, capable of generating an osmotic pressure which is higher than that of the first solution, is exposed to the side of the membrane opposite that exposed to the first solution. This exposure may be achieved by many techniques, but may include immersion of the membrane in the second solution (though not if immersion is used for the first solution) or the direction of the second solution past the membrane surface. The membrane, being impermeable to all or some of the species of the first solution, such as salts, charged and/or large molecules, microorganisms, and particulate matter, but allowing the passage of the solvent, such as water, allows the difference in osmotic pressure between the first and second solutions to induce a flux of water through the membrane from the first to the second solution. This flux may be allowed to significantly, partly, or largely not dilute the second solution and/or concentration the first solution. Some, none, few, or one of the select or target species of the first solution may also be expected to pass through the membrane, depending on the membrane type and/or the intention of the process use.

A portion of the solvent-enriched second solution is directed (via stream 1) to a draw solute separation operation (3), such as a distillation column, membrane distillation operation, or pervaporation operation, which causes the solutes in the solvent-enriched second solution, for example ammonia and carbon dioxide solutes, including species of ammonium salts, to be removed, by adding heat to the draw solute separation operation (3) and/or applying a pressure difference to the gases above and/or produced by the draw solute separation operation. This produces a solvent stream, designated stream 2, which is reduced in concentration of the species of stream 1, either partially, substantially, or completely, and a gas stream, designated stream 3, containing the removed species from stream 1. Stream 3 is directed to an operation designated to reconstitute the second solution which will be used to augment, replace, or maintain the characteristics of the second solution, such as volume or concentration. This operation may include dissolving the species in water, a portion of the second solution, precipitation and mixing with the second solution or some other method, such that the species removed in 3 are reintroduced to the second solution. This reintroduction is shown as the dashed stream 4. Rejected components of solution 1 may be removed from solution 1, periodically or continuously, as water is removed from this solution. This operation may include settling, hydrocyclone separation, precipitation, force gradient (such as electrical or magnetic), blowdown or other unit operation. This stream of components removed from 1 is shown as stream 5. In some embodiments, stream 5 may be a desired product stream or may be discarded as waste. By these techniques, osmotic pressure is used to remove solvent from a solution by osmotically driven flux through a semi-permeable membrane, for example separating solvent from a pharmaceutical compound, food product, or other desired species in solution, or treating a process stream by the removal of undesired solutes to produce a purified product stream.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

It is to be appreciated that embodiments of the devices, systems and methods discussed herein are not limited in application to the details of construction and the arrangement of components set forth in the following description or illustrated in the accompanying drawings. The devices, systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A forward osmosis separation process, comprising:
introducing a first solution comprising a solvent and at least one target species on a first side of a semi-permeable membrane;
introducing a second solution comprising ammonia and carbon dioxide in a molar ratio of at least 1:1 on a second side of the semi-permeable membrane, thereby forming an osmotic concentration gradient across the semi-permeable membrane which promotes the flow of at least a portion of the solvent of the first solution across the semi-permeable membrane to form a third solution on the first side of the semi-permeable membrane and a fourth solution on the second side of the semi-permeable membrane;
promoting the flow of at least a portion of the fourth solution to a separation operation to thereby generate draw solutes and a solvent stream;
returning the draw solutes to the second side of the semi-permeable membrane; and
recovering the at least one target species from the third solution.

2. The process of claim 1, wherein the first solution is an aqueous solution.

3. The process of claim 1, wherein the first solution comprises a stream from a pharmaceutical or food grade operation.

4. The process of claim 3, wherein the target species comprises a salt, sugar, enzyme, protein or microorganism.

5. The process of claim 1, wherein introducing the first solution on a first side of the semi-permeable membrane comprises immersing the semi-permeable membrane in the first solution.

6. The process of claim 4, wherein introducing the second solution comprises directing the second solution along the second side of the semi-permeable membrane.

7. The process of claim 1, wherein the first solution is introduced continuously.

8. The process of claim 1, wherein introducing at least a portion of the fourth solution to a separation operation comprises introducing at least a portion of the fourth solution to a distillation column, membrane distillation system or pervaporation system.

9. The process of claim 8, further comprising supplying waste heat to the separation operation.

10. The process of claim 8, further comprising processing the solvent stream.

11. The process of claim 1, wherein recovering the at least one target species comprises introducing the third solution to a settling vessel, hydrocyclone, precipitator, or force gradient operation.

12. The process of claim 11, further comprising introducing the at least one recovered target species to a further treatment unit.

13. The process of claim 12, further comprising supplying the at least one treated target species to a downstream point of use.

14. A forward osmosis waste treatment process, comprising:
introducing a first solution comprising a solvent and at least one constituent on a first side of a semi-permeable membrane;
introducing a concentrated draw solution comprising ammonia and carbon dioxide in a molar ratio of at least 1:1 on a second side of the semi-permeable membrane to maintain an osmotic concentration gradient across the semi-permeable membrane;
promoting flow of at least a portion of the solvent of the first solution across the semi-permeable membrane to form a second solution on the first side of the semi-permeable membrane and a dilute draw solution on the second side of the semi-permeable membrane;
introducing at least a portion of the dilute draw solution to a separation operation to thereby generate draw solutes and a solvent stream;
returning the draw solutes to the second side of the semi-permeable membrane; and
removing the at least one constituent from the second solution.

15. The process of claim 14, wherein the first solution comprises wastewater.

16. The process of claim 15, wherein the first solution comprises salts, organic matter, suspended colloids or biological organisms.

17. The process of claim 14, wherein introducing the first solution on the first side of the semi-permeable membrane comprises immersing the semi-permeable membrane in the first solution.

18. The process of claim 14, wherein introducing the concentrated draw solution comprises directing the concentrated draw solution along the second side of the semi-permeable membrane.

19. The process of claim 14, wherein the first solution is introduced continuously.

20. The process of claim 14, wherein introducing at least a portion of the dilute draw solution to a separation operation comprises introducing at least a portion of the dilute draw solution to a distillation column, membrane distillation system or pervaporation system.

21. The process of claim 20, further comprising supplying waste heat to the separation operation.

22. The process of claim 14, further comprising processing the solvent stream.

23. The process of claim 14, wherein removing the at least one constituent comprises introducing the second solution to a settling vessel, hydrocyclone or blowdown operation.

24. The process of claim 23, further comprising introducing the at least one constituent to a further treatment operation.

25. A forward osmosis separation process, comprising:
introducing a first solution comprising a solvent and at least one precipitable solute on a first side of a semi-permeable membrane;
introducing a second solution comprising ammonia and carbon dioxide in a molar ratio of at least 1:1 on a second side of the semi-permeable membrane, thereby forming an osmotic concentration gradient across the semi-permeable membrane that promotes the flow of at least a portion of the solvent of the first solution across the semi-permeable membrane to form a third solution on the first side of the semi-permeable membrane and a fourth solution on the second side of the semi-permeable membrane;
promoting the flow of at least a portion of the fourth solution to a separation operation to thereby generate draw solutes and a solvent stream;
returning the draw solutes to the second side of the semi-permeable membrane; and
recovering the at least one precipitable solute from the third solution.

26. The process of claim 25, wherein the at least one precipitable solute comprises an ionic salt species selected from the group consisting of chloride, sulfate, bromide, silicate, iodide, phosphate, sodium, magnesium, calcium, potassium, nitrate, arsenic, lithium, boron, strontium, molybdenum, manganese, aluminum, cadmium, chromium, cobalt, copper, iron, lead, nickel, selenium, silver, and zinc.
